(19) United States
(12) Patent Application Publication
(10) Pub. No.: US 2007/0188917 A1
(43) Pub. Date: Aug. 16, 2007

(54) Layered magnetic film and magnetic head

(75) Inventors: Junichi Kane, Kawasaki (JP); Yuji Uehara, Kawasaki (JP); Kenji Noma, Kawasaki (JP); Akifumi Chikazawa, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/430,034

(22) Filed: May 8, 2006

(30) Foreign Application Priority Data
Feb. 16, 2006 (JP) 2006-038898

(51) Int. Cl. G11B 5/147

(52) U.S. Cl. 360/126

(57) ABSTRACT

The layered magnetic film has high saturation magnetic flux density and superior soft magnetic characteristics and can be used as a material of a write-head of a magnetic head capable of recording data with high recording density. The layered magnetic film comprises: at least one magnetic layer mainly made of iron (Fe) and cobalt (Co); and at least one NiFe layer, the magnetic layer and the NiFe layer are alternately layered, and the NiFe layer is a discontinuous film.

### BACKGROUND OF THE INVENTION

The present invention relates to a layered magnetic film, which has high saturation magnetic flux density and superior soft magnetic characteristics, and a magnetic head using the layered magnetic film.

Surface recording density of recording media have been increased, so that recording bits of recording media have been made smaller and smaller, e.g., several hundred nm. With such minute recording bits, a problem of thermal agitation of magnetic minute particles occurs. To solve the problem, coercive forces (Hc) of recording media are increased. However, if the coercive forces are increased, a write-head of a magnetic head must generate a write-magnetic field with higher intensity, so a magnetic film of a write-magnetic pole must have high saturation magnetic flux density (Bs). Further, the write-magnetic pole must have high magnetic response (high-frequency characteristics), so the magnetic film of the write-magnetic pole must have superior soft magnetic characteristics.

A FeCo alloy has high saturation magnetic flux density, e.g., 2.45T, but its magnetostrictive constant is great, e.g., λ=30-70×10⁻⁶. Therefore, it is difficult to soft-magnetize a single-layered FeCo alloy film, so the single-layered FeCo alloy film cannot be used as a magnetic material of the write-magnetic pole. Magnetic permeability is one of indexes of soft magnetism. If the magnetic permeability of the write-magnetic pole is low, magnetization of the magnetic pole hardly responds to an induced magnetic field of a coil, which corresponds to waveforms of recording bits, so that resolution of recording bits must be lowered and desired writing characteristics cannot be gained.

To solve above described problems, many kinds of materials have been developed. For example, a base layer is provided immediately under a FeCo alloy film as a buffer; a small quantity of an additive element is added to an alloy; a FeCoN layer is formed on a base made of permalloy (Ni80Fe20) or sandwiched by permalloy layers so as to improve soft magnetic characteristics; a granular alloy film is formed by adding an additive element to FeCo so as to gain soft magnetism and high saturation magnetic flux density (see Japanese Patent Gazette No. 10-270246); and magnetic layers, which are mainly made of Fe and Co, and insulating layers, which are discontinuous films, are alternately layered (see International Publication Gazette WO2004/097806 A1).

However, conventional magnetic films do not have enough Bs values and soft magnetism for a material of a write-magnetic pole of a magnetic head. The magnetic film disclosed in the International Publication Gazette WO2004/097806 A1 have high Bs, high magnetic permeability, high write-magnetic field intensity and high resolution, so it can be suitably used for the write-magnetic pole of the magnetic head. However, the magnetic layers and the insulating layers, which are made of, for example, alumina, are alternately layered. If the FeCo alloy, which is an electric conductor, and alumina, which is a insulator, are used as targets of film formation in the same chamber, the electric conductor and the insulator are mixed in the chamber so that pure magnetic layers and pure insulating layers cannot be formed. Further, if the magnetic layers and the insulating layers are separately formed, the film formation process must be complex.

### SUMMARY OF THE INVENTION

The present invention was conceived to solve the above described problems.

An object of the present invention is to provide a layered magnetic film, which has high saturation magnetic flux density and superior soft magnetic characteristics and which can be used as a material of a write-head of a magnetic head capable of recording data with high recording density.

Another object is to provide a magnetic head having said layered magnetic film.

To achieve the objects, the present invention has following structures.

Namely, the layered magnetic film of the present invention comprises: at least one magnetic layer mainly made of iron (Fe) and cobalt (Co); and at least one NiFe layer, the magnetic layer and the NiFe layer are alternately layered, and the NiFe layer is a discontinuous film.

In the layered magnetic film, average thickness of the NiFe layer may be equal to surface roughness of the magnetic layer or less, so that the NiFe layer can be formed as the discontinuous film.

In the layered magnetic film, the NiFe layer may be formed on a surface of the magnetic layer like a cluster, so that the NiFe layer can be formed as the discontinuous film.

In the layered magnetic film, number and thickness of the layers may be adjusted to make entire saturation magnetic flux density 2.2T or more.

The magnetic head comprises a write-head, which includes an upper magnetic pole, a lower magnetic pole and a write-gap formed between the magnetic poles, and a magnetic film constituting the write-gap is the above described layered magnetic film. Another magnetic head is a vertical recording magnetic head comprising a return yoke, and a magnetic film constituting the return yoke is the above described layered magnetic film. With these structures, the magnetic heads have superior high-frequency characteristics and are capable of recording data with high recording density.

The layered magnetic film of the present invention has high saturation magnetic flux density and superior soft magnetic characteristics, and can be use as a suitable material for a magnetic head of a magnetic disk drive unit. In case of using the layered magnetic film for a write-head of the magnetic head, the magnetic head can have a high intensity write-magnetic field and high resolution. Even if a coercive force of a recording medium is increased to improve surface recording density, the magnetic head can suitably work.

### BRIEF DESCRIPTION OF THE DRAWINGS

Embodiments of the present invention will now be described by way of examples and with reference to the accompanying drawings, in which:

FIG. 1 is a schematic view of an embodiment of the layered magnetic film of the present invention;

FIG. 2 is an explanation view showing a detail structure of the layered magnetic film;

FIG. 3 is a graph showing B-H curves of a FeCo single-layered film;

FIG. 4 is a graph showing B-H curves of a layered magnetic film, which includes FeCo films and NiFe films whose thickness is 2 nm;

FIG. 5 is a graph showing B-H curves of a layered magnetic film, which includes FeCo films and NiFe films whose thickness is 5 nm;

FIG. 6 is a graph showing B-H curves of a layered magnetic film, which includes FeCo films and NiFe films whose thickness is 10 nm;

FIG. 7 is a sectional view of a magnetic head using the layered magnetic film of the present invention; and

FIG. 8 is a sectional view of another magnetic head using the layered magnetic film of the present invention.

### DETAILED DESCRIPTION OF THE EMBODIMENTS

Preferred embodiments of the present invention will now be described in detail with reference to the accompanying drawings.

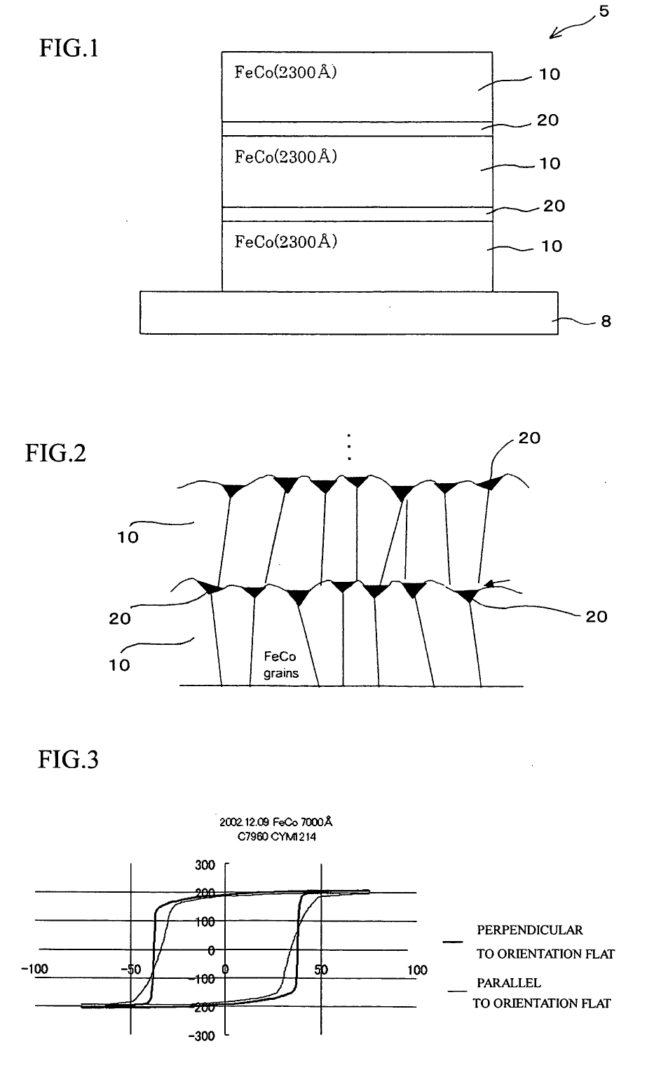

FIG. 1 is a schematic view of an embodiment of the layered magnetic film of the present invention. In the layered magnetic film, magnetic layers, which are mainly made of iron (Fe) and cobalt (Co), and NiFe layers, which are soft magnetic layers, are alternately layered. In FIG. 1, the layered magnetic film 5 has a substrate 8, three magnetic layers, which are mainly made of iron (Fe) and cobalt (Co), and two NiFe layers 20, each of which is sandwiched between the magnetic layers 10. Namely, the layered magnetic film 5 has a five-layered structure.

Thickness of the magnetic layers 10 and the NiFe layers 20 can be optionally determined. Number of layers of the layered magnetic film 5 may be optionally determined. The magnetic layers 10 and the NiFe layers 20 may be formed by spattering, vapor deposition or plating. The thickness of the magnetic layers 10 and the NiFe layers 20 may be adjusted by selecting the method and conditions for forming the layers.

The feature of the layered magnetic film 5 of the present embodiment is that the NiFe layers 20, each of which is formed on the magnetic layer 10, are discontinuous films.

FIG. 2 is an enlarged view showing a film structure of the layered magnetic film 5. In the magnetic layer 10, FeCo is formed as crystal grains, and a surface is a concavo-convex surface. When the magnetic layer 10 has the concavo-convex surface, average thickness of the NiFe layer 20, which is formed on the magnetic layer 10, is equal to surface roughness of the magnetic layer or less, so that the NiFe layer 20 can be formed as the discontinuous film. Namely, when the NiFe layer 20 is formed on the surface of the magnetic layer 10, thickness of the NiFe layer 20 is made relatively thin so as to discontinuously cover the surface of the magnetic layer 10 with the NiFe layer 20.

Note that, since the surface of the magnetic layer 10 is the concavo-convex surface, the NiFe layer 20 can be deposited on the surface of the magnetic layer 10 like a cluster by forming the relatively thin NiFe layer 20. By depositing the NiFe layer 20 like a cluster, concaves of the surface of the magnetic layer 10 can be filled.

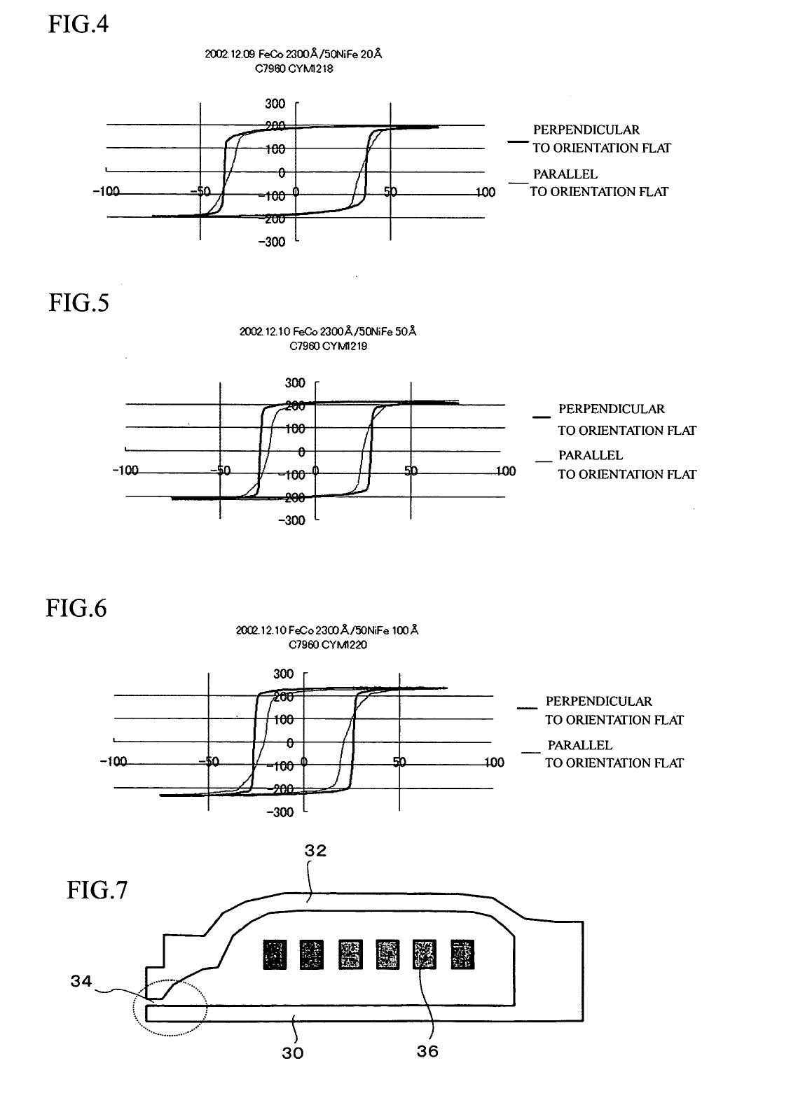

FIGS. 4-6 are graphs showing B-H curves of the five-layered magnetic film 5 shown in FIG. 1, which includes three magnetic films 10 and the NiFe films 20, each of which is sandwiched between the magnetic films 10. Note that, FIG. 3 is a graph of a comparative example, which shows B-H curves of a single-layered film of Fe70Co30 (thickness: 700 nm) including no NiFe layer.

The detail structure of the layered magnetic film of FIG. 4 is Fe70Co30 (230 nm)/50NiFe (2 nm)/Fe70Co30 (230 nm)/50NiFe (2 nm)/Fe70Co30 (230 nm).

The detail structure of the layered magnetic film of FIG. 5 is Fe70Co30 (230 nm)/50NiFe (5 nm)/Fe70Co30 (230 nm)/50NiFe (5 nm)/Fe70Co30 (230 nm).

The detail structure of the layered magnetic film of FIG. 6 is Fe70Co30 (230 nm)/50NiFe (10 nm)/Fe70Co30 (230 nm)/50NiFe (10 nm)/Fe70Co30 (230 nm).

Substrates of the samples were Al₂O₃—TiC, and the magnetic layers 10 and the NiFe layers 20 were formed on the substrates by spattering. Conditions of spattering were as follows: pressure 0.1-3 Pa; electric power density 1-10×10⁻⁴W/m²; flow volume of argon (Ar) 50-100 sccm; targets Fe70Co30 and 50iFe; and a clearance between the substrate and the target 90-180 mm.

The B-H curves shown in FIGS. 3-6 were measured, by a B-H loop tracer, in directions parallel to orientation flats of wafers and in directions perpendicular thereto with applying a magnetic field of ±700 e.

According to the results, soft magnetic characteristics of the layered magnetic films, in each of which the magnetic layers 10 and the NiFe layers 20 were alternately layered, were superior to those of the single-layered film of Fe70o30. Especially, in case that the thickness of the 50NiFe layers were 5 nm and 10 nm, the soft magnetic characteristics were remarkably improved. In case that the thickness of the NiFe layers 20 were 2 nm, 5 nm and 10 nm, we suspected that the NiFe layer 20 discontinuously covered the surface of the magnetic layer 10 as shown in FIG. 2.

Saturation magnetic flux density (Bs) of the samples of FIGS. 4-6 were measured. Bs values of all samples were Bs>2.2T. Namely, the Bs values similar to that of the single-layered film of Fe70Co30 were gained. The Bs values were measured, by a SQUID, with applying a magnetic field of 10 kOe.

According to the measured data, the layered magnetic film, in which the FeCo magnetic layers 10 and the NiFe layers 20 were alternately layered and the NiFe layers 20 were discontinuously formed, had superior soft magnetic characteristics and high saturation magnetic flux density of the FeCo magnetic layers 10. By having the high saturation magnetic flux density and the superior soft magnetic characteristics, the layered magnetic films can be suitably used as pole materials of a magnetic head.

FIG. 7 shows a structure of a write-head of a horizontal recording magnetic head. The write-head comprises a lower magnetic pole 30 and an upper magnetic pole 32. A write-gap 34 is formed between front ends of the magnetic poles 30 and 32. A symbol 36 stands for a coil. The lower magnetic pole 30 and the upper magnetic pole 32 are made of a ferromagnetic material, e.g., NiFe. To increase writing accuracy of the write-head, a strong magnetic field must be generated around the write-gap 34 and high-frequency characteristics of the write-gap 34 must be superior. By forming the layered magnetic films of the present invention on facing surfaces in the write-gap 34, the high saturation magnetic flux density and the superior soft magnetic characteristics of the layered magnetic films are capable of highly improving recording density and resolution of the magnetic head.

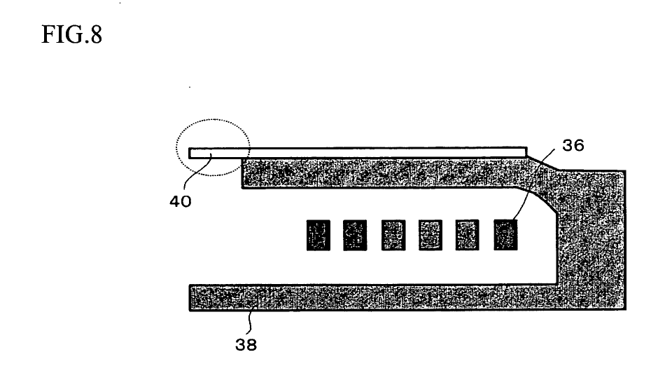

FIG. 8 shows a structure of a write-head of a vertical recording magnetic head, which comprised a main magnetic pole 38 and a return yoke 40. In this case, the layered magnetic film of the present invention is provided to a front end of the return yoke 40, so that recording density and resolution of the vertical recording magnetic head can be highly improved.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A layered magnetic film, comprising:
at least one magnetic layer mainly made of iron (Fe) and cobalt (Co); and
at least one NiFe layer,
wherein said magnetic layer and said NiFe layer are alternately layered, and
said NiFe layer is a discontinuous film.

2. The layered magnetic film according to claim 1,
wherein average thickness of said NiFe layer is equal to surface roughness of said magnetic layer or less, so that said NiFe layer can be formed as the discontinuous film.

3. The layered magnetic film according to claim 1,
wherein said NiFe layer is formed on a surface of said magnetic layer like a cluster, so that said NiFe layer can be formed as the discontinuous film.

4. The layered magnetic film according to claim 1,
wherein number and thickness of said layers are adjusted to make entire saturation magnetic flux density 2.2T or more.

5. The layered magnetic film according to claim 2,
wherein number and thickness of said layers are adjusted to make entire saturation magnetic flux density 2.2T or more.

6. The layered magnetic film according to claim 3,
wherein number and thickness of said layers are adjusted to make entire saturation magnetic flux density 2.2T or more.

7. A magnetic head comprising a write-head, which includes an upper magnetic pole, a lower magnetic pole and a write-gap formed between the magnetic poles,
wherein a magnetic film constituting the write-gap comprises: at least one magnetic layer mainly made of iron (Fe) and cobalt (Co); and at least one NiFe layer, and
said magnetic layer and said NiFe layer are alternately layered, and said NiFe layer is a discontinuous film.

8. A vertical recording magnetic head comprising a return yoke,
wherein a magnetic film constituting said return yoke comprises: at least one magnetic layer mainly made of iron (Fe) and cobalt (Co); and at least one NiFe layer, and
said magnetic layer and said NiFe layer are alternately layered, and said NiFe layer is a discontinuous film.
